(19) United States
(12) Patent Application Publication
(10) Pub. No.: US 2026/0063498 A1
(43) Pub. Date: Mar. 5, 2026

(54) TEMPERATURE CYCLE TEST BENCH FOR SEAL MATERIAL PERFORMANCE

(71) Applicant: Tsinghua University, Beijing (CN)

(72) Inventors: Fei Guo, Beijing (CN); Yijie Huang, Beijing (CN)

(21) Appl. No.: 19/011,852

(22) Filed: Jan. 7, 2025

(30) Foreign Application Priority Data
Aug. 30, 2024 (CN) 2024112131638

(51) Int. Cl. G01M 3/28

(52) U.S. Cl. CPC G01M 3/2869

(57) ABSTRACT

The present application relates to the field of test device, and provides a partitioned contact temperature cycle test bench for seal material performance, including a temperature control device, a support device and a drive device, where the temperature control device includes a first thermostatic module and a second thermostatic module, the first thermostatic module is provided with a first thermal conduction surface, the second thermostatic module is provided with a second thermal conduction surface, the first thermal conduction surface and the second thermal conduction surface enclose a receive cavity, and temperature of the first thermostatic module is different from temperature of the second thermostatic module; the support device supports a piece to be tested, the support device is rotatably provided in the receive cavity, the support device is provided with a thermal conduction portion, the thermal conduction portion is in contact with the piece to be tested, and the thermal conduction portion is in contact with any one of the first thermal conduction surface and the second thermal conduction surface; and the drive device drives the support device to rotate relative to the temperature control device. Such an arrangement solves the problem in the related art that the temperature cycle test device cannot alternately change rapidly in a wide temperature range.

### FIELD

The present application relates to the field of test device, and in particular, to a partitioned contact temperature cycle test bench for seal material performance.

### BACKGROUND

A seal ring is generally made of elastic materials, such as rubber, polyurethane, silicone, etc., which has elasticity and flexibility. The seal ring may adapt to different surface shapes and motion states, and maintains good sealing performance. The seal ring may adopt different materials, structures and sizes depending on the application requirements and working environment. The seal ring is often used in closed systems or equipment, such as automobile engines, hydraulic systems, pneumatic systems, pipeline connections, etc., and plays an important role in preventing fluid or gas leakage and maintaining the sealing performance of the system. In these application scenarios, the seal ring is often subjected to severe temperature changes, and it is necessary to ensure that the seal ring can maintain stable sealing performance within a wide temperature range. In general, it is necessary to perform a temperature cycle test on the seal ring in a wide temperature range to simulate the temperature changes experienced by the seal ring in actual use, and to determine the impact of temperature changes on the material properties, structural properties and sealing performance of the seal ring.

In the related art, a temperature cycle test device is used to simulate temperature changes. The traditional temperature cycle test device mainly uses thermal conduction media, thermoelectric devices, etc. in conjunction with temperature control systems, sensors, control software, etc. for temperature cycle effects. In a procedure, the thermoelectric device is used to heat or cool the thermal conduction medium, and then the thermal conduction medium is used to transfer heat to a piece to be tested. When the temperature cycle is stimulated in a wide temperature range, the thermoelectric device heats the thermal conduction medium from low temperature to high temperature and cools the thermal conduction medium from high temperature to low temperature, which takes a certain amount of time, cannot alternately change rapidly, and affects the accuracy and stability of the test data.

Therefore, how to solve the problem that the temperature cycle test device in the related art cannot alternately and rapidly change the temperature in a wide temperature range has become an important problem to be solved by those skilled in the art.

### BRIEF SUMMARY

Embodiments of the present application provide a partitioned contact temperature cycle test bench for seal material performance to solve the defect that the temperature cycle test device in the related art cannot alternately and rapidly change the temperature in a wide temperature range.

An embodiment of the present application provides a partitioned contact temperature cycle test bench for seal material performance, including:
a temperature control device, including a first thermostatic module and a second thermostatic module, where the first thermostatic module is provided with a first thermal conduction surface, the second thermostatic module is provided with a second thermal conduction surface, the first thermal conduction surface and the second thermal conduction surface enclose a cylindrical receive cavity, and temperature of the first thermostatic module is different from temperature of the second thermostatic module;
a support device, used for supporting a piece to be tested, where the support device is rotatably provided in the receive cavity, both a rotation axis of the support device and an axis of the receive cavity coincide with a reference axis, the support device is provided with a thermal conduction portion, the thermal conduction portion is in contact with the piece to be tested, and the thermal conduction portion is in contact with any one of the first thermal conduction surface and the second thermal conduction surface; and
a drive device, used for driving the support device to rotate relative to the temperature control device.

According to the partitioned contact temperature cycle test bench for seal material performance provided by the present application, both the first thermostatic module and the second thermostatic module are provided in group, and one group of the first thermostatic modules and one group of the second thermostatic modules are alternately spaced along a circle.

According to the partitioned contact temperature cycle test bench for seal material performance provided by the present application, one group of the first thermostatic modules include an even number of the first thermostatic modules, one group of the second thermostatic modules include an even number of the second thermostatic modules, and the support device includes:
a mount seat, connected to the drive device;
a pair of support assemblies, provided at the mount seat, where the pair of support assemblies are arranged around the reference axis in a rotational symmetry manner.

According to the partitioned contact temperature cycle test bench for seal material performance provided by the present application, the partitioned contact temperature cycle test bench for seal material performance further includes:
a base, where both the first thermostatic module and the second thermostatic module are slidably connected to the base, and the first thermostatic module and the second thermostatic module approach or move away from the reference axis;
a first elastic member, provided between the first thermostatic module and the base, where the first elastic member is used for approaching the first thermostatic module to the reference axis; and
a second elastic member, provided between the second thermostatic module and the base, where the second elastic member is used for approaching the second thermostatic module to the reference axis.

According to the partitioned contact temperature cycle test bench for seal material performance provided by the present application, the drive device is switchable between a first state and a second state;
in the first state, the support device rotates in a forward direction, and the first thermostatic module and the second thermostatic module alternately approach and move away from the reference axis; and in the second state, the support device rotates in a reverse direction, the first thermostatic module and the second thermostatic module are fixed, and the first thermal conduction surface and the second thermal conduction surface enclose to form the receive cavity.

According to the partitioned contact temperature cycle test bench for seal material performance provided by the present application, the drive device includes:
a push rod assembly, including a push rod disk and push rods, where the push rod disk is rotatably provided around the reference axis in the receive cavity, the push rods are slidably connected to the push rod disk to approach or move away from the reference axis, each of the first thermostatic modules corresponds to one of the push rods, each of the second thermostatic modules corresponds to one of the push rods, and the push rod disk is able to drive the support device to rotate;
a special-shaped cam, coaxially provided with and rotatably connected to the push rod disk, where the special-shaped cam is provided with transmission portions, each of the push rods corresponds to one of the transmission portions, two sides of the transmission portion are provided with a first match position and a second match position along a circumference direction of the push rod disk, a distance between the first match position and the reference axis is a first distance, a distance between the second match position and the reference axis is a second distance, the first distance is smaller than the second distance, a second guide surface is formed between two adjacent transmission portions, the first match position is smoothly connected to the second guide surface, and the second match position is smoothly connected to the second guide surface; and
a drive member, connected to the special-shaped cam in a transmission manner.

According to the partitioned contact temperature cycle test bench for seal material performance provided by the present application, the first thermostatic module and the second thermostatic module are both provided with a guide block, and a side surface of the guide block facing the push rod is a first guide surface;
a distance between a first end of the first guide surface along a circumference direction of the first guide surface and the reference axis is a third distance, a distance between a second end of the first guide surface along the circumference direction of the first guide surface and the reference axis is a fourth distance, and the third distance is greater than the fourth distance;
in case that the push rod is in the first match position, a distance between an end of the push rod away from the reference axis and the reference axis is a fifth distance, and the fourth distance is greater than or equal to the fifth distance; and
in case that the push rod is in the second match position, a distance between the end of the push rod away from the reference axis and the reference axis is a sixth distance, the third distance is greater than or equal to the sixth distance, and the fourth distance is smaller than the sixth distance.

According to the partitioned contact temperature cycle test bench for seal material performance provided by the present application, the drive device further includes:
a groove wheel assembly provided between the drive member and the special-shaped cam, where a groove wheel of the groove wheel assembly is connected to the special-shaped cam in a transmission manner, and an active drive disk of the groove wheel assembly is connected to the drive member in a transmission manner.

According to the partitioned contact temperature cycle test bench for seal material performance provided by the present application, the support assembly includes:
a thermal conduction shell, fixedly provided at the mount seat, where the thermal conduction shell is provided with a chamber with a cross-section in a shape of an annular sector, and an end of the thermal conduction shell away from the mount seat is openly provided; and
a support block, with a cross-section in the shape of an annular sector, the support block is provided with a receive groove for receiving the piece to be tested, the receive groove extends along a circumference direction of the support block, the support block is movably matched with the thermal conduction shell, the support block is switchable between a first position and a second position, in the first position, the support block is located inside the thermal conduction shell and the piece to be tested is in contact with the thermal conduction shell, and in the second position, the support block is located outside the thermal conduction shell.

According to the partitioned contact temperature cycle test bench for seal material performance provided by the present application, the support block is slidably matched with the thermal conduction shell, a slide direction of the support block relative to the thermal conduction shell is parallel to the reference axis, and the support device further includes:
a rotator, rotatably provided around the reference axis at the mount seat;
a connection frame, where the support blocks of the pair of support assemblies are both connected to a first end of the connection frame, the connection frame is slidably matched with the rotator, a slide direction of the connection frame relative to the rotator is parallel to the reference axis, a second end of the connection frame is provided with an abutment disk, and the abutment disk is provided with an abutment rod;
an abutment block, slidably connected to the mount seat to approach or move away from the reference axis, where a side surface of the abutment block facing the abutment rod is an abutment surface, a distance between an end of the abutment surface close to the reference axis and the abutment disk is a seventh distance, a distance between an end of the abutment surface away from the reference axis and the abutment disk is an eighth distance, and the seventh distance is different from the eighth distance;
a connection rod, where an end of the connection rod is rotatably connected to the abutment block, and another end of the connection rod is rotatably connected to the rotor; and
a third elastic member, provided between the rotator and the connection frame, and the third elastic member is used for making the connection frame drive the abutment disk close to the abutment surface.

According to the partitioned contact temperature cycle test bench for seal material performance provided by the present application, a fill port for filling a medium into the thermal conduction shell is provided at the support block, and the support assembly further includes:
a seal member, for sealing the fill port, where the seal member is detachably and sealedly connected to the support block.

The partitioned contact temperature cycle test bench for seal material performance provided by the present application includes a temperature control device, a support device, and a drive device. The temperature control device includes a first thermostatic module and a second thermostatic module, where the first thermostatic module is provided with a first thermal conduction surface, the second thermostatic module is provided with a second thermal conduction surface, and the first thermal conduction surface and the second thermal conduction surface enclose a cylindrical receive cavity. The support device is rotatably provided in the receive cavity, and both a rotation axis of the support device and an axis of the receive cavity coincide with a reference axis. The support device is provided with a thermal conduction portion, and the thermal conduction portion may contact any one of the first thermal conduction surface and the second thermal conduction surface. The drive device may drive the support device to rotate relative to the temperature control device. In case that the support device rotates relative to the temperature control device, the thermal conduction portion may contact the first thermal conduction surface and the second thermal conduction surface alternately. The temperature of the first thermostatic module is different from the temperature of the second thermostatic module. In case that the thermal conduction portion contacts the first thermal conduction surface, the temperature of the thermal conduction portion is consistent with the temperature of the first thermostatic module; in case that the thermal conduction portion contacts the second thermal conduction surface, the temperature of the thermal conduction portion is consistent with the temperature of the second thermostatic module. The support device is used to support the piece to be tested, and the thermal conduction portion may contact the piece to be tested to provide a test temperature environment for the piece to be tested. By such arrangement, the first thermostatic module may be kept at a higher and constant temperature, and the second thermostatic module may be kept at a lower and constant temperature. When it is necessary to simulate a high temperature for the piece to be tested, the support device is rotated and the thermal conduction portion contacts the first thermostatic module. When it is necessary to simulate a low temperature for the piece to be tested, the support device is rotated and the thermal conduction portion contacts the second thermostatic module. By making the thermal conduction portion contact the first thermal conduction surface and the second thermal conduction surface cyclically and alternately, the piece to be tested may be rapidly alternating between high and low temperatures, which solves the problem in the related art that the temperature cycle test device cannot alternately and rapidly change the temperature in a wide temperature range.

### BRIEF DESCRIPTION OF THE DRAWINGS

In order to illustrate the solutions disclosed in the embodiments of the present application more clearly, the drawings used in the description of the embodiments are briefly described below. The drawings in the following description are only some embodiments of the present application, and other drawings may be obtained according to these drawings without any creative work for those skilled in the art.

FIG. 1 is a schematic structural diagram of a partitioned contact temperature cycle test bench for seal material performance according to the present application;

FIG. 2 is an exploded view of a partitioned contact temperature cycle test bench for seal material performance according to the present application (not showing a drive member);

FIG. 3 is a schematic structural diagram of a temperature control device when a drive member is in a second state according to the present application;

FIG. 4 is a schematic structural diagram of a temperature control device when a drive member is in a first state according to the present application;

FIG. 5 is a schematic structural diagram of a guide block according to the present application;

FIG. 6 is a schematic structural diagram of a drive device according to the present application (not showing a drive member);

FIG. 7 is a schematic structural diagram of a push rod when located at a first match position of a special-shaped cam according to the present application;

FIG. 8 is a schematic structural diagram of a push rod when located at a second match position of a special-shaped cam according to the present application;

FIG. 9 is a schematic structural diagram of a special-shaped cam according to the present application;

FIG. 10 is a schematic structural diagram of a groove wheel assembly according to an embodiment of the present application;

FIG. 11 is a schematic structural diagram of a support device according to the present application;

FIG. 12 is a cross-sectional view of a support device according to the present application;

FIG. 13 is a schematic structural diagram at one viewing angle of a thermal conduction shell according to the present application;

FIG. 14 is a schematic structural diagram at another viewing angle of a thermal conduction shell according to the present application;

FIG. 15 is a schematic structural diagram of a support assembly according to the present application (not showing a thermal conduction shell);

FIG. 16 is a schematic structural diagram of a rotator and an abutment block according to the present application;

FIG. 17 is a temperature change curve of a piece to be tested when a drive device of a partitioned contact temperature cycle test bench for seal material performance is in a second state according to the present application; and

FIG. 18 is a temperature change curve of a piece to be tested when a drive device of a partitioned contact temperature cycle test bench for seal material performance is in a first state according to the present application.

### REFERENCE SIGNS

1: temperature control device; 2: first thermostatic module; 3: second thermostatic module; 4: cylindrical pin; 5: guide plate; 6: support device; 7: drive device; 8: mount seat; 9: push rod disk; 10: push rod; 11: special-shaped cam; 12: first match position; 13: second match position; 14: second guide surface; 15: guide block; 16: first guide surface; 17: groove wheel assembly; 18: thermal conduction shell; 19: support block; 20: rotor; 21: connection frame; 22: abutment disk; 23: abutment rod; 24: abutment block; 25: abutment surface; 26: connection rod; 27; third elastic member; 28: first guide rail; 29: second guide rail; 30: active drive disk; 31: fixed block; 32: transmission block; 33: transmission groove; 34: groove wheel.

### DETAILED DESCRIPTION

To illustrate the objectives, solutions, and advantages of the application more clearly, the solutions in the present application are described clearly and completely below in combination with the drawings in the application. The described embodiments are part of the embodiments of the application, not all of them. All other embodiments obtained by those skilled in the art based on the embodiments of the present application without creative effort belong to the scope of the present application.

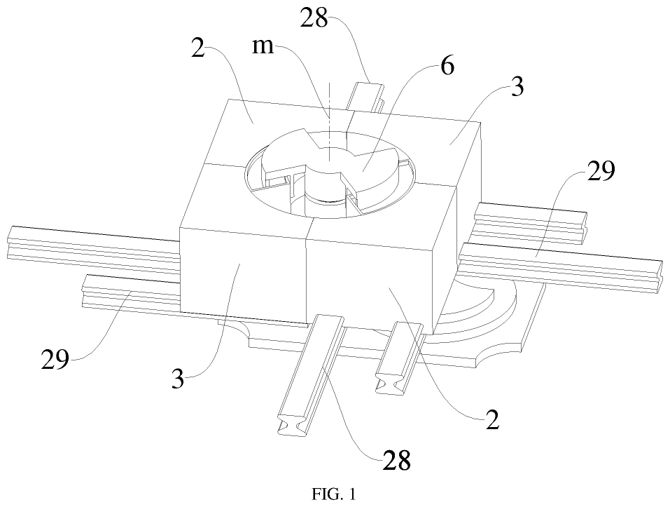

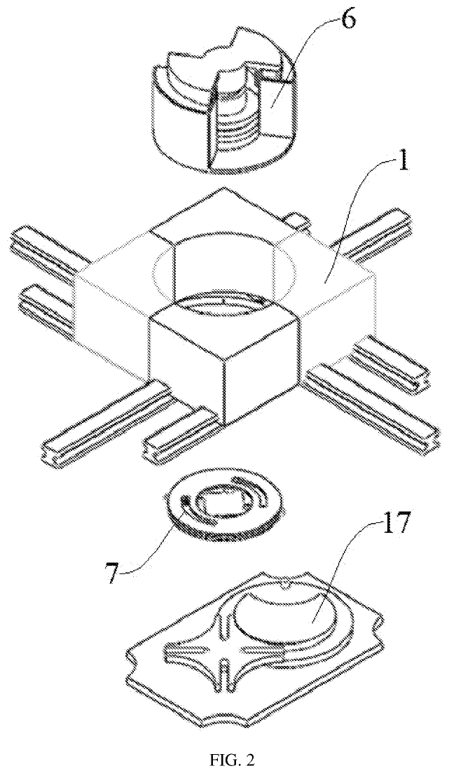

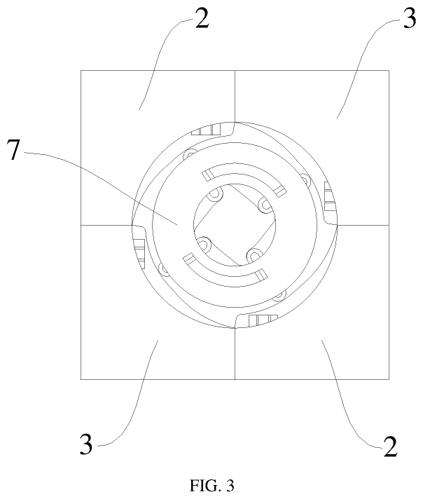

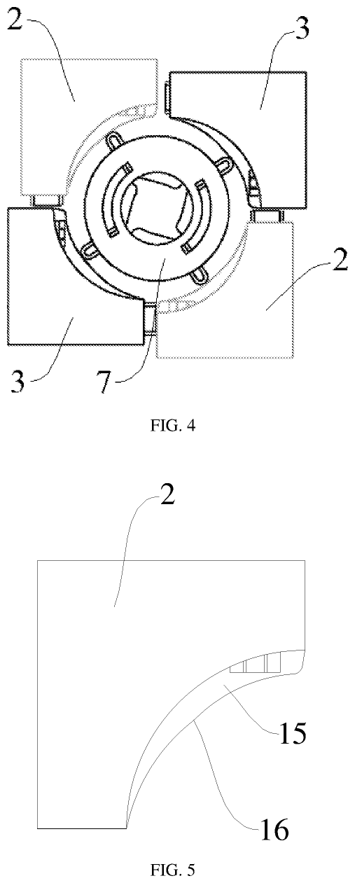

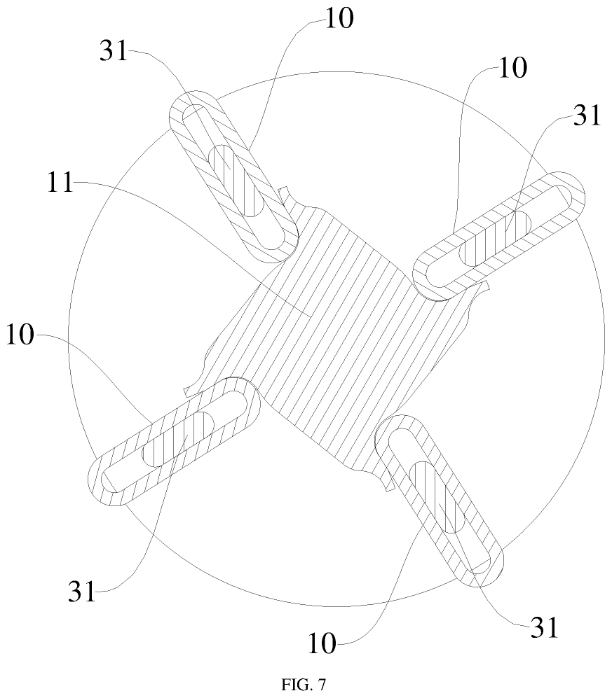

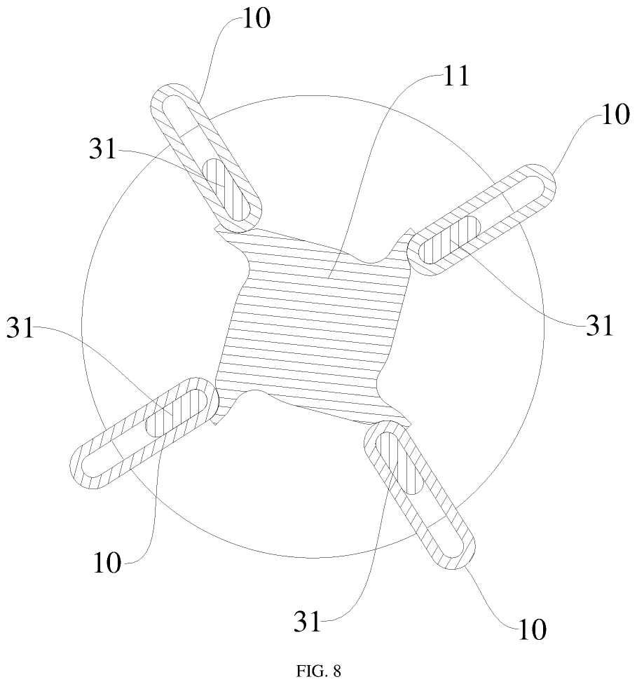

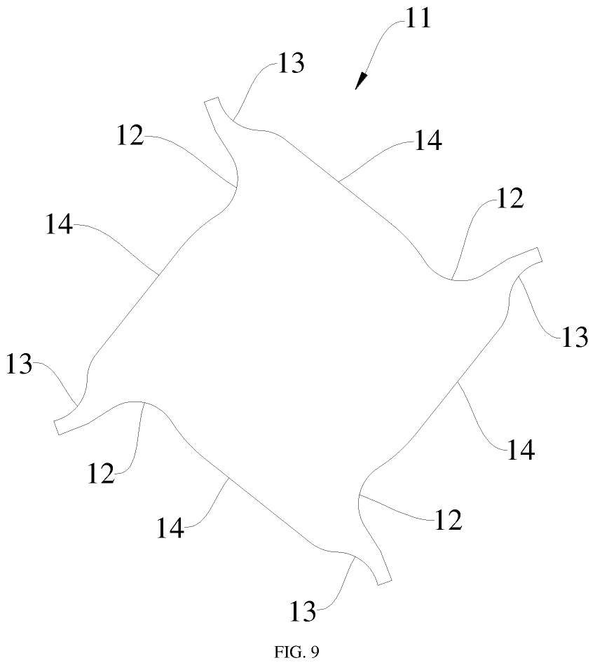

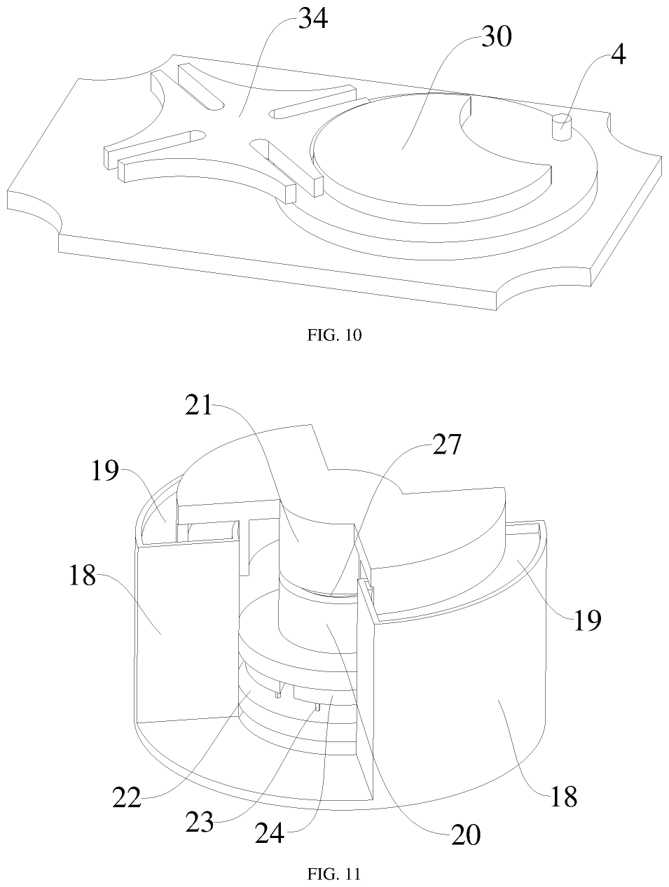

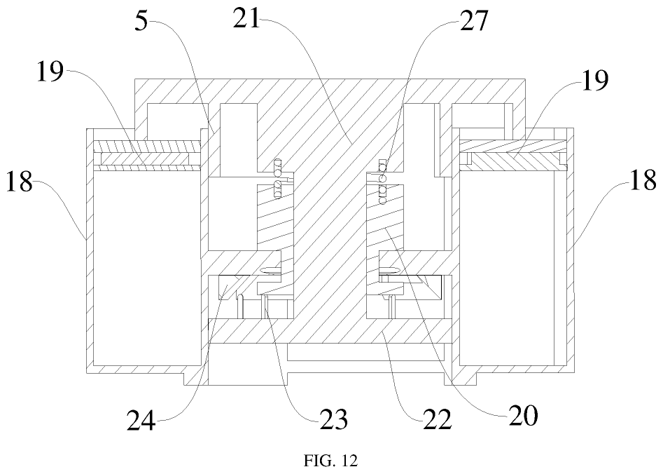

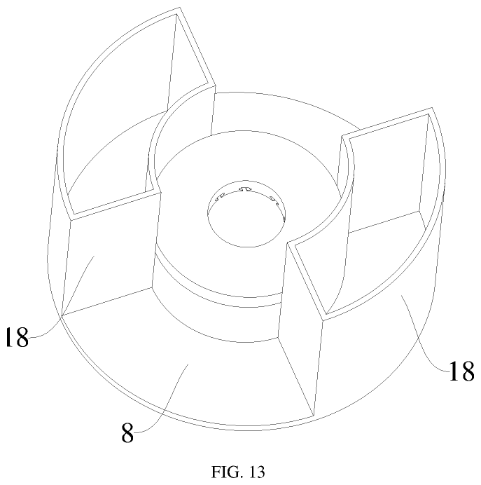

The partitioned contact temperature cycle test bench for seal material performance provided by embodiments of the present application is described below in conjunction with FIG. 1 to FIG. 18.

As shown in FIG. 1 to FIG. 18, the partitioned contact temperature cycle test bench for seal material performance provided by the embodiments of the present application includes a temperature control device 1, a support device 6 and a drive device 7.

In an embodiment, the temperature control device 1 includes a first thermostatic module 2 and a second thermostatic module 3, the first thermostatic module 2 is provided with a first thermal conduction surface, the second thermostatic module 3 is provided with a second thermal conduction surface, and the first thermal conduction surface and the second thermal conduction surface may enclose to form a cylindrical receive cavity.

The support device 6 is rotatably provided in the receive cavity, and both a rotation axis of the support device 6 and an axis of the receive cavity coincide with a reference axis, and the reference axis refers to the straight line indicated by m in FIG. 1. The support device 6 is provided with a thermal conduction portion, and the thermal conduction portion may contact any one of the first thermal conduction surface and the second thermal conduction surface.

The drive device 7 may drive the support device 6 to rotate relative to the temperature control device 1, and in case that the support device 6 rotates relative to the temperature control device 1, the thermal conduction portion may alternately contact the first thermal conduction surface and the second thermal conduction surface.

Temperature of the first thermostatic module 2 is different from temperature of the second thermostatic module 3. The temperature of the first thermostatic module 2 may be kept constant at a higher temperature, and the temperature of the second thermostatic module 3 may be kept constant at a lower temperature. In case that the thermal conduction portion contacts the first thermal conduction surface, the temperature of the thermal conduction portion is consistent with the temperature of the first thermostatic module 2; in case that the thermal conduction portion contacts the second thermal conduction surface, the temperature of the thermal conduction portion is consistent with the temperature of the second thermostatic module 3.

The support device 6 is used to support a piece to be tested, and the thermal conduction portion may contact the piece to be tested to provide a test temperature environment for the piece to be tested.

By such arrangement, the first thermostatic module 2 may be kept at a higher and constant temperature, and the second thermostatic module 3 may be kept at a lower and constant temperature. When it is necessary to simulate a high temperature for the piece to be tested, the support device 6 is rotated and the thermal conduction portion contacts the first thermostatic module 2. When it is necessary to simulate a low temperature for the piece to be tested, the support device 6 is rotated and the thermal conduction portion contacts the second thermostatic module 3. By making the thermal conduction portion contact the first thermal conduction surface and the second thermal conduction surface cyclically and alternately, the piece to be tested may be rapidly alternating between high and low temperatures, which solves the problem in the related art that the temperature cycle test device cannot alternately and rapidly change the temperature in a wide temperature range.

It should be noted that the constant temperatures of the first thermostatic module 2 and the second thermostatic module 3 rely on thermal conduction medium, thermoelectric device, semiconductor cooling plate, etc., and in case that the thermal conduction portion is in contact with any one of the first thermal conduction surface and the second thermal conduction surface, the thermoelectric device and the semiconductor cooling plate both control the temperatures of the first thermostatic module 2 and the second thermostatic module 3 in real time. However, after the partitioned contact temperature cycle test bench for seal material performance starts, the first thermostatic module 2 and the second thermostatic module 3 do not have a large range of temperature fluctuations, and there is no need to take up time to adjust the temperatures of the first thermostatic module 2 and the second thermostatic module 3 separately, which avoids the procedures of heating the first thermostatic module 2 from low temperature to high temperature and cooling the second thermostatic module 3 from high temperature to low temperature, saves the time required for heating and cooling the first thermostatic module 2 and the second thermostatic module 3, respectively. It is only necessary to set the temperatures for the first thermostatic module 2 and the second thermostatic module 3 based on a target wide temperature range when the partitioned contact temperature cycle test bench for seal material performance starts. Therefore, the partitioned contact temperature cycle test bench for seal material performance provided by the embodiments of the present application is fully capable of adapting to the alternating temperature changes in a wide temperature range.

In an embodiment of the present application, both the first thermostatic module 2 and the second thermostatic module 3 are provided in group, and one group of the first thermostatic modules 2 and one group of the second thermostatic modules 3 are alternately spaced along a circle. That is, all the first thermostatic modules 2 and all the second thermostatic modules 3 are alternately spaced along a circle, a second thermostatic module 3 is provided between two adjacent first thermostatic modules 2, and a first thermostatic module 2 is provided between two adjacent second thermostatic modules 3.

By such arrangement, the support device 6 may contact the first thermal conduction surface multiple times and contact the second thermal conduction surface multiple times during one rotation, which changes the temperature of the piece to be tested alternately between high and low temperatures many times.

It should be noted that in order to avoid the mutual influence between the temperatures of the adjacent first thermostatic module 2 and the second thermostatic module 3, thermal insulation layers may be provided at surfaces where the first thermostatic module 2 is in contact with the second thermostatic module 3.

In this embodiment, one group of the first thermostatic modules 2 include an even number of the first thermostatic modules 2, one group of the second thermostatic modules 3 include an even number of the second thermostatic modules 3. Referring to FIG. 1 to FIG. 4, one group of first thermostatic modules 2 includes two first thermostatic modules 2, and one group of second thermostatic modules 3 includes two second thermostatic modules 3.

In an embodiment, the support device 6 includes a mount seat 8 and a pair of support assemblies. The mount seat 8 is connected to the drive device 7, the pair of support assemblies are provided at the mount seat 8, and the pair of support assemblies are arranged around the reference axis in a rotational symmetry manner.

By such arrangement, the pair of support assemblies may support two pieces to be tested at the same time and the two pieces to be tested may be tested at the same time. In case that the drive device 7 drives the mount seat 8 to rotate to a certain position, both pair of the support assemblies correspond to the first thermostatic module 2 at the same time, or both pair of the support assemblies correspond to the second thermostatic module 3 at the same time. In other words, the test procedure and test time of the two pieces to be tested are completely consistent, and the test results of the two pieces to be tested are compared and verified with each other, which is conducive to improving the accuracy of the test results.

In an embodiment, the partitioned contact temperature cycle test bench for seal material performance provided by the embodiments of the present application further includes a base, a first elastic member and a second elastic member.

Both the first thermostatic module 2 and the second thermostatic module 3 are slidably connected to the base, and the first thermostatic module 2 and the second thermostatic module 3 may approach or move away from the reference axis.

The first elastic member is provided between the first thermostatic module 2 and the base, and the first elastic member may make the first thermostatic module 2 tend to approach the reference axis. The second elastic member is provided between the second thermostatic module 3 and the base, and the second elastic member may make the second thermostatic module 3 tend to approach the reference axis.

In case that the first thermostatic module 2 and the second thermostatic module 3 are not subjected to other external forces, the first thermostatic module 2 and the second thermostatic module 3 enclose to form a cylindrical receive cavity. At this time, the first thermal conduction surface and the second thermal conduction surface may both contact the thermal conduction portion.

In case that the first thermostatic module 2 and the second thermostatic module 3 are subjected to an external force in a direction away from the reference axis, the first thermostatic module 2 and the second thermostatic module 3 overcome the force of the first elastic member and the second elastic member, slide in a direction away from the reference axis, and the first thermal conduction surface and the second thermal conduction surface are both out of contact with the thermal conduction portion of the support device 6.

In an embodiment, a first guide rail 28 may be provided for each first thermostatic module 2, and a second guide rail 29 may be provided for each second thermostatic module 3. The first guide rail 28 is used to guide the sliding of the first thermostatic module 2, and the second guide rail 29 is used to guide the sliding of the second thermostatic module 3.

In this embodiment, the drive device 7 may switch between a first state and a second state.

In case that the drive device 7 switches to the second state, the drive device 7 drives the support device 6 to rotate in a reverse direction, and an effect of the drive device 7 on the first thermostatic module 2 and the second thermostatic module 3 is invalid. Under the action of the first elastic member and the second elastic member, the first thermostatic module 2 and the second thermostatic module 3 are maintained at a position where the first thermal conduction surface and the second thermal conduction surface are enclosed to form the receive cavity.

In this case, when the support device 6 rotates, the thermal conduction portion alternately contacts the first thermal conduction surface and the second thermal conduction surface. Moreover, in the procedure of switching from the thermal conduction portion being completely in contact with the first thermal conduction surface to the thermal conduction portion being completely in contact with the second thermal conduction surface, a part of the thermal conduction portion contacts the first thermal conduction surface, and the other part of the thermal conduction portion contacts the second thermal conduction surface, and the temperature of the thermal conduction portion is between the temperature of the first thermostatic module 2 and the temperature of the second thermostatic module 3. That is, the temperatures of the thermal conduction portion and the piece to be tested change gradually.

In case that the driving device 7 switches to the first state, the drive device 7 drives the support device 6 to rotate in a positive direction, and may drive the first thermostatic module 2 and the second thermostatic module 3 to alternately approach and move away from the reference axis.

In this case, a timing of the first thermostatic module 2 and the second thermostatic module 3 approaching or moving away from the reference axis may be controlled by some technical means. For example, when the thermal conduction portion of the support device 6 is facing the first thermostatic module 2 completely, the first thermostatic module 2 and the second thermostatic module 3 are located close to the reference axis, and the thermal conduction portion of the support device 6 is completely in contact with the first thermal conduction surface, and the temperature of the thermal conduction portion and the piece to be tested is instantly consistent with the temperature of the first thermostatic module 2. When the support device 6 rotates, the first thermostatic module 2 and the second thermostatic module 3 move away from the reference axis, and the thermal conduction portion of the support device 6 is separated from the first thermal conduction surface and the second thermal conduction surface. At this time, the temperature of the thermal conduction portion is basically unchanged and not affected by the temperature of the second thermostatic module 3, and is maintained at a temperature consistent with the first thermostatic module 2. When the support device 6 rotates to a point where its thermal conduction portion is facing the second thermostatic module 3 completely, the first thermostatic module 2 and the second thermostatic module 3 are located close to the reference axis, and the thermal conduction portion of the support device 6 is completely in contact with the second thermal transfer surface. At this time, the temperature of the thermal conduction portion and the piece to be tested is instantly consistent with the temperature of the second thermostatic module 3. That is, the temperature of the thermal conduction portion and the piece to be tested changes instantly.

With such arrangement, by controlling the state of the drive device 7, different temperature changes may be simulated, and the performance of the piece to be tested under different temperature changes may be tested, which is more applicable.

In an embodiment, the drive device 7 includes a push rod assembly, a special-shaped cam 11, and a drive member.

The push rod assembly includes a push rod disk 9 and push rods 10. The push rod disk 9 is provided in the receive cavity. An axis of the push rod disk 9 coincides with the reference axis, and the push rod disk 9 may rotate around the reference axis. Each of the first thermostatic modules 2 corresponds to one of the push rods 10, and each of the second thermostatic modules 3 corresponds to one of the push rods 10.

The push rods 10 are slidably connected to the push rod disk 9 to approach or move away from the reference axis. In an embodiment, the push rod disk 9 may be provided in a circular shape and the axes of the push rods 10 are provided along the radial direction of the push rod disk 9. Slide grooves are provided at the push rods 10, and the slide grooves extend along axial directions of the push rods 10. Fixed blocks 31 are provided at the push rod disk 9, and the fixed blocks 31 extend along a radial direction of the push rod disk 9. Extension lengths of the fixed blocks 31 are smaller than extension lengths of the slide grooves. In case that the fixed block 31 is in the slide groove, the fixed block 31 slides relative to the slide groove, which allows the push rod 10 to slide back and forth along the radial direction of the push rod disk 9.

The fixed blocks 31 extend along the radial direction of the push rod disk 9, that is, the fixed blocks 31 are provided in a long strip shape, which increases the contact area between the fixed blocks 31 and the push rods 10, may minimize the contact stress during the action process, and is conducive to extending the service life of the drive device 7.

An axis of the special-shaped cam 11 coincides with the axis of the push rod disk 9, and the special-shaped cam 11 is rotatably connected to the push rod disk 9.

In an embodiment, the push rod disk 9 includes two parallel disk bodies with a spacing between the two disk bodies, the fixed blocks 31 and the push rods 10 are provided between the two disk bodies, and the two disk bodies are both fixedly connected to the fixed blocks 31. The special-shaped cam 11 is located between the two disk bodies, and a wheel axle of the special-shaped cam 11 penetrates through one of the disk bodies for transmission-connection with the drive member, and the special-shaped cam 11 rotates under the driving action of the drive member.

The special-shaped cam 11 is provided with transmission portions, and each of the push rods 10 corresponds to one of the transmission portions.

Two sides of the transmission portion have a first match position 12 and a second match position 13 along a circumference direction of the push rod disk 9. A distance between the first match position 12 and the reference axis is a first distance, and a distance between the second match position 13 and the reference axis is a second distance, and the first distance is smaller than the second distance. That is, in case that the push rod 10 interacts with the first match position 12 of the transmission portion, a distance between an end of the push rod 10 away from the reference axis and the reference axis is relatively small; in case that the push rod 10 interacts with the second match position 13 of the transmission portion, the distance between the end of the push rod 10 away from the reference axis and the reference axis is relatively large.

Each of the transmission portions of the special-shaped cam 11 is located between two adjacent push rods 10, and the special-shaped cam 11 may rotate reciprocally within a certain angle range. Accordingly, each of the transmission portions may reciprocate between two adjacent push rods 10.

In case that the special-shaped cam 11 rotates in a reverse direction, when the first match position 12 of the transmission portion contacts the push rod 10, the special-shaped cam 11 continues to rotate, the transmission portion may generate a force on the push rod 10, and the force has a component force perpendicular to an axial direction of the push rod 10, and the push rod 10 and the push rod disk 9 rotate synchronously in the reverse direction around the reference axis with the special-shaped cam 11.

In case that the special-shaped cam 11 rotates in the forward direction, when the second match position 13 of the transmission portion contacts the push rod 10, the special-shaped cam 11 continues to rotate, the transmission portion may generate a force on the push rod 10, and the force has a component force perpendicular to the axial direction of the push rod 10, and the push rod 10 and the push rod plate 9 rotate synchronously in the forward direction around the reference axis with the special-shaped cam 11.

A second guide surface 14 is formed between two adjacent transmission portions, and the first match position 12 is smoothly connected to the second guide surface 14, and the second match position 13 is smoothly connected to the second guide surface 14. In case that the push rod 10 contacts the first match position 12, a distance between an end of the push rod 10 close to the reference axis and the reference axis is smaller than a distance between the second match position 13 and the reference axis. By providing the second guide surface 14, in case that the special-shaped cam 11 starts to rotate forward, the push rod 10 gradually moves away from the reference axis until the distance between the end of the push rod 10 close to the reference axis and the reference axis is consistent with the distance between the second match position 13 and the reference axis, and the push rod 10 may smoothly contact the second match position 13.

It should be noted that the first match position 12 and the second match position 13 are grooves formed in the transmission portion of the special-shaped cam 11. By designing the grooves, the push rod 10 may match the grooves. On the premise of meeting the position requirements of the push rod 10 and the requirements of the direction of the force of the transmission portion on the push rod 10, it is ensured that the first match position 12 and the second match position 13 may both contact the surface of the push rod 10, which increases the contact area between the push rod 10 and the transmission portion.

In this embodiment, a transmission structure is provided between the push rod disk 9 and the support device 6, and the push rod disk 9 drives the support device 6 to rotate synchronously.

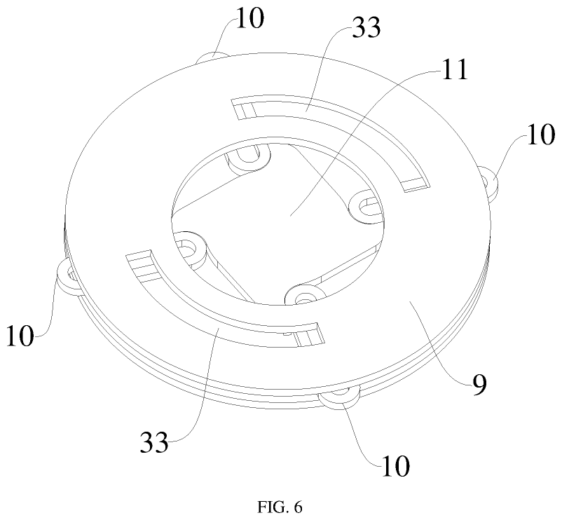

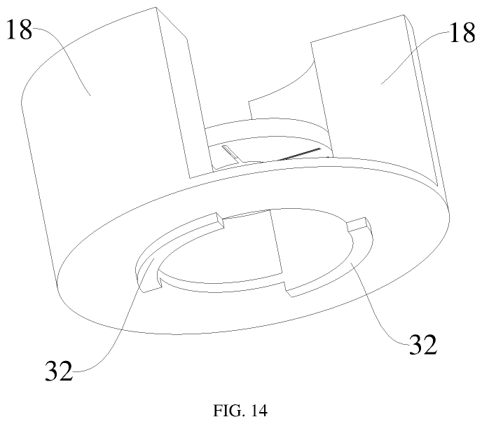

In an embodiment, the transmission structure includes transmission blocks 32 and transmission grooves 33, where the transmission blocks 32 are provided at the support device 6, and the transmission grooves 33 are provided at the push rod disk 9. In case that the support device 6 is placed on the push rod disk 9, the transmission blocks 32 are in the transmission grooves 33. In case that the push rod disk 9 rotates, the support device 6 may be driven to rotate synchronously through the interaction between the transmission blocks 32 and the transmission grooves 33. Referring to FIG. 6 and FIG. 14, the transmissions block 32 and the transmission grooves 33 are all in the shape of an arc, and the centers of the arcs are located on the axis of the push rod disk 9.

In an embodiment, a guide block 15 is provided at both the first thermostatic module 2 and the second thermostatic module 3, and the guide block 15 is located at an end of the first thermostatic module 2 and the second thermostatic module 3 close to the push rod disk 9. A side surface of the guide block 15 facing the push rod 10 is a first guide surface 16.

The first guide surface 16 has a first end and a second end along a circumference direction of the first guide surface 16. In an embodiment, in case that the special-shaped cam 11 rotates in the forward direction, one of the two ends of the first guide surface 16 that the push rod 10 passes through first is the first end of the first guide surface 16, and the other that the push rod 10 passes through later is the second end of the first guide surface 16.

A distance between the first end of the first guide surface 16 and the reference axis is a third distance, and a distance between the second end of the first guide surface 16 and the reference axis is a fourth distance, and the third distance is greater than the fourth distance. In an embodiment, a distance between the first guide surface 16 and the reference axis gradually decreases in a direction from the first end to the second end thereof.

In case that the push rod 10 is located at the first match position 12, a distance between the end of the push rod 10 away from the reference axis and the reference axis is a fifth distance, and the fourth distance is greater than or equal to the fifth distance. In case that the special-shaped cam 11 rotates in the reverse direction, there is a spacing between the end of the push rod 10 away from the reference axis and any position of the first guide surface 16, and the push rod 10 does not contact any position of the first guide surface 16; or, the end of the push rod 10 away from the reference axis contacts the second end of the first guide surface 16, and the push rod 10 does not contact any other position of the first guide surface 16.

That is, in case that the special-shaped cam 11 rotates in the reverse direction, the push rod 10 does not generate a force on the first thermostatic module 2 and the second thermostatic module 3, and the first thermostatic module 2 and the second thermostatic module 3 are gathered under the action of the first elastic member and the second elastic member, and enclosed to form the cylindrical receive cavity. During the reverse rotation of the special-shaped cam 11, the first thermostatic module 2 and the second thermostatic module 3 are always gathered, which corresponds to the second state of the drive device 7.

In case that the push rod 10 is located at the second match position 13, a distance between the end of the push rod 10 away from the reference axis and the reference axis is a sixth distance, the third distance is greater than or equal to the sixth distance, and the fourth distance is smaller than the sixth distance. In case that the special-shaped cam 11 rotates in the forward direction, the end of the push rod 10 away from the reference axis just contacts or does not contact the first end of the first guide surface 16, and the push rod 10 does not generate a force on the first thermostatic module 2 and the second thermostatic module 3. The first thermostatic module 2 and the second thermostatic module 3 are gathered under the action of the first elastic member and the second elastic member, and enclosed to form the cylindrical receive cavity, and the thermal conduction portion of the support device 6 contacts the first thermal conduction surface.

However, as the special-shaped cam 11 rotates, the end of the push rod 10 away from the reference axis gradually contacts the remaining positions of the first guide surface 16, and generates a thrust on the first guide surface 16 in the direction away from the reference axis, the first thermostatic module 2 and the second thermostatic module 3 slide in the direction away from the reference axis, and the first thermal conduction surface and the second thermal conduction surface are both out of contact with the thermal conduction portion of the support device 6.

Until the special-shaped cam 11 rotates to a position where the first end of the push rod 10 faces the next first guide surface 16 directly, the thrust of the push rod 10 on the first guide surface 16 disappears, and the first thermostatic module 2 and the second thermostatic module 3 are instantly gathered under the action of the first elastic member and the second elastic member. At this time, the thermal conduction portion of the support device 6 is in contact with the second thermal conduction surface.

In sequence, the first thermostatic module 2 and the second thermostatic module 3 alternately approach and move away from the reference axis, and the first thermostatic module 2 and the second thermostatic module 3 alternately gather and disperse, which corresponds to the first state of the drive device 7.

In an embodiment, the first guide surface 16 is an arc surface, which can make the first thermostatic module 2 and the second thermostatic module 3 slide at a relative stable speed when sliding, which improves the stability of the partitioned contact temperature cycle sealing material performance test bench.

The first elastic member and the second elastic member mentioned above may be, but are not limited to, springs.

The drive member may be, but is not limited to, a motor.

In an embodiment of the present application, the drive device 7 further includes a groove wheel assembly 17, and the groove wheel assembly 17 is provided between the drive member and the special-shaped cam 11. The groove wheel assembly 17 includes a groove wheel 34 and an active drive disk 30, an axis of the groove wheel 34 coincides with an axis of the special-shaped cam 11, the groove wheel 34 is connected to the special-shaped cam 11 in a transmission manner, and the groove wheel 34 may drive the special-shaped cam 11 to rotate. The active drive disk 30 is connected to the drive member in a transmission manner, and the drive member may drive the active drive disk 30 to rotate. The active drive disk 30 has a cylindrical pin 4, and the groove wheel 34 may be driven to rotate intermittently.

In case that the active drive disk 30 rotates one circle, the groove wheel 34 drives the special-shaped cam 11 to rotate 90 degrees, the push rod 10 passes through a first guide surface 16, and the support device 6 switches from a state where the thermal conduction portion corresponds to one of the first thermostatic module 2 and the second thermostatic module 3 to a state where the thermal conduction portion corresponds to the other.

The time when the thermal conduction portion of the support device 6 completely corresponds to the first thermostatic module 2 or the second thermostatic module 3 is three quarters of the rotation cycle of the active drive disk 30.

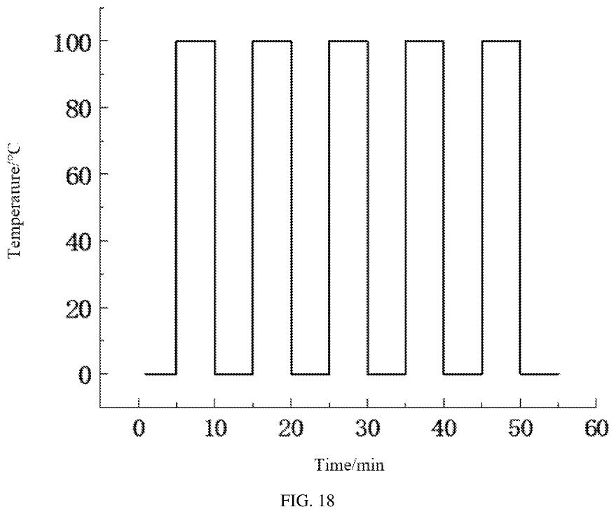

In case that the partitioned contact temperature cycle test bench for seal material performance provided by the embodiments of the present application is used to test the piece to be tested, if the drive device 7 is in the first state, the temperature change curve of the piece to be tested is a step curve as shown in FIG. 18; if the drive device 7 is in the second state, the temperature change curve of the piece to be tested is a linear change curve as shown in FIG. 17. The temperature values and time values in the above curves are only exemplary, and the temperature value depends on the temperatures of the first thermostatic module 2 and the second thermostatic module 3. The time value depends on the rotation speed of the support device 6.

In an embodiment of the present application, the support assembly includes a thermal conduction shell 18 and a support block 19.

The thermal conduction shell 18 is fixedly provided at the mount seat 8, where the thermal conduction shell 18 is provided with a chamber with a cross-section in a shape of an annular sector, an end of the thermal conduction shell 18 away from the mount seat 8 is openly provided, and an opening direction of the thermal conduction shell 18 is parallel to the reference axis. A cross-section of the support block 19 is in the shape of an annular sector, and the support block 19 may enter and exit the thermal conduction shell 18.

A receive groove is provided at the support block 19 for receiving the piece to be tested. The receive groove extends along a circumference direction of the support block 19. The piece to be tested may be a seal material such as a seal ring, the seal ring may be sleeved at the support block 19, and the seal ring is in the receive groove. In case that the seal ring is sleeved at the support block 19 and the support block 19 is in the thermal conduction shell 18, the seal ring contacts the thermal conduction shell 18, that is, the thermal conduction shell 18 may serve as the thermal conduction portion of the support device 6.

It should be noted that an outer arc surface of the thermal conduction shell 18 is used to contact the first thermal conduction surface and the second thermal conduction surface. The thermal conduction shell 18 itself has a thermal-conducting property, and the temperature at the position of the inner arc surface of the thermal conduction shell 18 is consistent with the temperature at the position of the outer arc surface of the thermal conduction shell 18, which ensures the temperature uniformity of the thermal conduction shell 18.

The thermal conduction shell 18 in this embodiment needs to be made of a material with excellent thermal conductivity to ensure the temperature uniformity of the thermal conduction shell 18, a fast thermal conduction speed between the thermal conduction shell 18 and the first thermal conduction surface, and a fast thermal conduction speed between the thermal conduction shell 18 and the second thermal conduction surface.

In this embodiment, the support block 19 is movably matched with the thermal conduction shell 18, and the support block 19 may be switched between a first position and a second position. In case that the support block 19 is switched to the first position, the support block 19 is located inside the thermal conduction shell 18, and the piece to be tested may contact the thermal conduction shell 18. At this time, the test operation may be performed. In case that the support block 19 is switched to the second position, the support block 19 is located outside the thermal conduction shell 18. At this time, the piece to be tested may be mounted in the receive groove of the support block 19, or the piece to be tested that has been tested may be removed from the support block 19. Such a configuration facilitates the disassembly and assembly of the piece to be tested at the support device 6.

In case that the support block 19 is switched to the first position and the piece to be tested is in the receive groove of the support block 19, the piece to be tested makes the support block 19 and the thermal conduction shell 18 enclose to form a sealed chamber. A medium with a certain pressure may be filled in the thermal conduction shell 18. After the piece to be tested is subjected to a wide temperature range of temperature alternating cycles, the pressure in the thermal conduction shell 18 is monitored and the mass or concentration of the leaked seal medium is detected after the test is completed, the seal performance of the piece to be tested after the wide temperature range of temperature alternating cycles may be determined, and the performance test of pieces to be tested such as a seal material is completed.

In this embodiment, a fill port is provided at the support block 19, and the medium may be filled into the thermal conduction shell 18 through the fill port. The support assembly also includes a seal member, which is detachably sealed and connected to the support block 19, and the seal member may be used to seal the fill port.

In the embodiment of the present application, the support block 19 is slidably matched with the thermal conduction shell 18, and the sliding direction of the support block 19 relative to the thermal conduction shell 18 is parallel to the reference axis. By sliding the support block 19 relative to the thermal conduction shell 18, the position of the support block 19 in the thermal conduction shell 18 may be adjusted, and the volume of the sealed chamber enclosed by the support block 19 and the thermal conduction shell 18 is adjusted. Under the premise that the amount of medium filled in the thermal conduction shell 18 is certain, by adjusting the position of the support block 19 in the thermal conduction shell 18, the medium pressure may be adjusted, that is, the pressure of the environment in which the piece to be tested is located may be adjusted, and the temperature aging test of the piece to be tested under different medium pressures may be conducted.

A guide plate 5 is provided at a connection frame 21, and the guide plate 5 is in contact with the inner arc surface of the thermal conduction shell 18. Through the interaction between the guide plate 5 and the inner arc surface of the thermal conduction shell 18, the connection frame 21 may be guided for sliding, and the relative position of the support block 19 and the thermal conduction shell 18 in a radial direction may be ensured, which prevents the vibration during the test from affecting the pre-compression rate of the seal ring.

In a corresponding embodiment, the support device 6 also includes a rotator 20, a connection frame 21, an abutment block 24, a connection rod 26 and a third elastic member 27.

The rotator 20 is provided at the mount seat 8, the rotator 20 is rotatably connected to the mount seat 8, and a rotation axis of the rotator 20 relative to the mount seat 8 coincides with the reference axis. The rotator 20 may only rotate relative to the mounting seat 8, and the rotator 20 does not slide relative to the mount seat 8.

The connection frame 21 serves as a support structure of the support assembly, and a pair of support blocks 19 of the support assembly are connected to a first end of the connection frame 21. The connection frame 21 is provided penetrating an interior of the rotator 20, and the connection frame 21 and the rotator 20 are slidably matched, and the sliding direction of the connection frame 21 relative to the rotator 20 is parallel to the reference axis. In case that the connection frame 21 slides relative to the rotator 20, the support block 19 may be switched between the first position and the second position.

An abutment disk 22 is provided at a second end of the connection frame 21, and the abutment disk 22 is perpendicular to the reference axis. An abutment rod 23 is provided at the abutment disk 22.

The abutment block 24 is slidably connected to the mount seat 8. In case that the abutment block 24 slides relative to the mount seat 8, the abutment block 24 may approach or move away from the reference axis. In an embodiment, the abutment block 24 may be slidably connected to the mount seat 8 through a structure such as a dovetail groove.

A side surface of the abutment block 24 facing the abutment rod 23 is an abutment surface 25. A distance between an end of the abutment surface 25 close to the reference axis and the abutment disk 22 is a seventh distance, and a distance between an end of the abutment surface 25 away from the reference axis and the abutment disk 22 is an eighth distance, and the seventh distance is different from the eighth distance.

The third elastic member 27 is provided between the rotator 20 and the connection frame 21. The third elastic member 27 may make the connection frame 21 tend to drive the abutment disk 22 to approach the abutment surface 25.

In an embodiment, the abutment surface 25 may be an arc-shaped surface or an inclined plane.

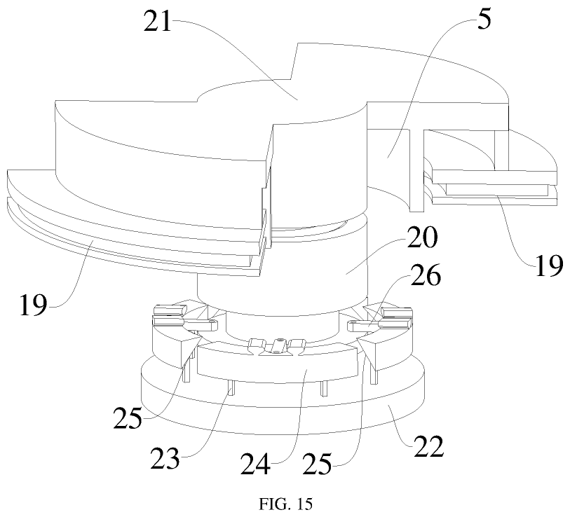

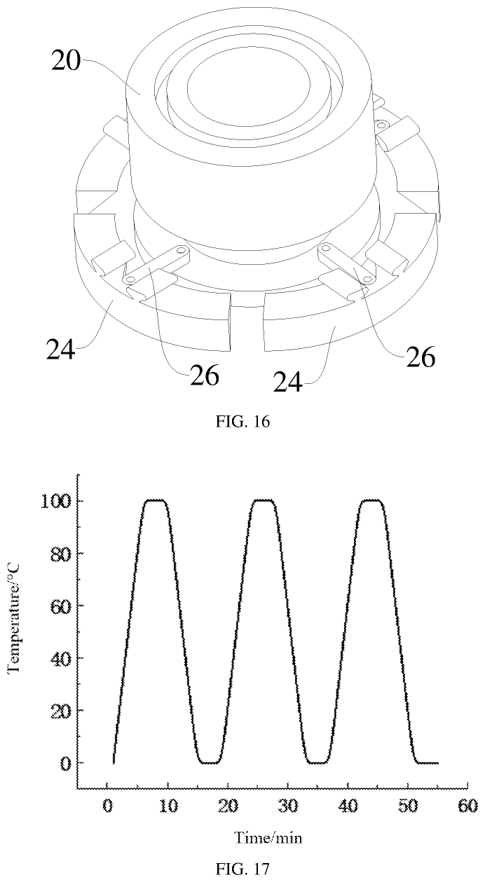

Referring to FIG. 15 and FIG. 16, the abutment block 24 is located at a side of the abutment disk 22 close to the support block 19. In case that the partitioned contact temperature cycle test bench for seal material performance is put into use, the abutment block 24 is located above the abutment disk 22. The abutment surface 25 is set as an inclined plane, and the seventh distance is greater than the eighth distance.

In case that the abutment block 24 is close to the reference axis, the interaction between the abutment surface 25 and the abutment rod 23 causes the abutment rod 23 to drive the abutment disk 22 away from the abutment block 24 along the reference axis direction, and the support block 19 switches to the first position.

In case that the abutment block 24 is away from the reference axis, the abutment block 24 allows the abutment rod 23 to drive the abutment disk 22 to approach the abutment block 24 along the reference axis, the third elastic member 27 is provided to prompt the connection frame 21 to drive the abutment disk 22 to approach the abutment block 24 along the reference axis, and support block 19 switches to the second position.

The third elastic member 27 may be, but is not limited to, a coil spring.

In an embodiment, the distances between the abutment block 24 and the reference axis are different, the positions of the support block 19 in the thermal conduction shell 18 are different, and the sealed chamber enclosed by the support block 19 and the thermal conduction shell 18 has different volumes. By adjusting the distance between the abutment block 24 and the reference axis, the volume of the sealed chamber enclosed by the support block 19 and the thermal conduction shell 18 may be adjusted.

The connection rod 26 is provided between the rotator 20 and the abutment block 24, an end of the connection rod 26 is rotatably connected to the abutment block 24, and another end of the connection rod 26 is rotatably connected to the rotator 20. A rotation axis of the connection rod 26 relative to the abutment block 24 and a rotation axis of the connection rod 26 relative to the rotator 20 are parallel. In case that the rotator 20 rotates relative to the mount seat 8, the rotator 20 may drive the abutment block 24 to slide relative to the mount seat 8 through the connection rod 26. In case of switching the position of the support block 19, it is only necessary to manually rotate the rotator 20.

In an embodiment, a plurality of abutment blocks 24 are provided, each of the abutment blocks 24 is spaced apart along a circumference direction of the abutment disk 22, each of the abutment blocks 24 is correspondingly provided with a connection rod 26, and each of the abutment blocks 24 is correspondingly provided with at least two abutment rods 23. Each of the abutment blocks 24 interacts with the abutment disk 22 at different positions, which may optimize the force at the abutment disk 22, improve the stability of the abutment disk 22 and the connection frame 21, ensure the smooth lifting and lowering of the support block 19, and avoid jamming.

It should be noted that the inclination angle of the above-mentioned abutment surface 25 relative to the abutment disk 22 is not limited, and may be determined based on the material and friction coefficient of the abutment block 24 and the abutment rod 23. After adjusting the position of the abutment block 24, the friction between the abutment block 24 and the abutment rod 23 may ensure the stability of the position of the abutment block 24 and the relative position between the support block 19 and the thermal conduction shell 18. In addition, during the use of the partitioned contact temperature cycle test bench for seal material performance, the piece to be tested such as the seal ring may also increase the friction between the support block 19 and the thermal conduction shell 18, which is conducive to improving the stability of the support block 19 during the test.

It should be noted that the above embodiments are only used to explain the solutions of the present application, and are not limited thereto; although the present application has been described in detail with reference to the foregoing embodiments, it should be understood by those skilled in the art that they may still modify the solutions recited in the foregoing embodiments and make equivalent substitutions to a part of the technical features; these modifications and substitutions do not make the essence of the corresponding solutions depart from the scope of the solutions of various embodiments of the present application.

What is claimed is:

1. A partitioned contact temperature cycle test bench for seal material performance, the partitioned contact temperature cycle test bench comprising:
a temperature control device, comprising a first thermostatic module and a second thermostatic module, wherein the first thermostatic module is provided with a first thermal conduction surface, the second thermostatic module is provided with a second thermal conduction surface, the first thermal conduction surface and the second thermal conduction surface enclose a cylindrical receive cavity, and temperature of the first thermostatic module is different from temperature of the second thermostatic module;
a support device, used for supporting a piece to be tested, wherein the support device is rotatably provided in the receive cavity, both a rotation axis of the support device and an axis of the receive cavity coincide with a reference axis, the support device is provided with a thermal conduction portion, the thermal conduction portion is in contact with the piece to be tested, and the thermal conduction portion is in contact with any one of the first thermal conduction surface and the second thermal conduction surface; and
a drive device, used for driving the support device to rotate relative to the temperature control device.

2. The partitioned contact temperature cycle test bench for seal material performance of claim 1, wherein both the first thermostatic module and the second thermostatic module are provided in group, and one group of the first thermostatic modules and one group of the second thermostatic modules are alternately spaced along a circle.

3. The partitioned contact temperature cycle test bench for seal material performance of claim 2, wherein one group of the first thermostatic modules comprise an even number of the first thermostatic modules, one group of the second thermostatic modules comprise an even number of the second thermostatic modules, and
the support device comprises:
a mount seat, connected to the drive device; and
a pair of support assemblies, provided at the mount seat, wherein the pair of support assemblies are arranged around the reference axis in a rotational symmetry manner.

4. The partitioned contact temperature cycle test bench for seal material performance of claim 1, further comprising:
a base, wherein both the first thermostatic module and the second thermostatic module are slidably connected to the base, and the first thermostatic module and the second thermostatic module approach or move away from the reference axis;
a first elastic member, provided between the first thermostatic module and the base, wherein the first elastic member is used for approaching the first thermostatic module to the reference axis; and
a second elastic member, provided between the second thermostatic module and the base, wherein the second elastic member is used for approaching the second thermostatic module to the reference axis.

5. The partitioned contact temperature cycle test bench for seal material performance of claim 4, wherein the drive device is switchable between a first state and a second state;
in the first state, the support device rotates in a forward direction, and the first thermostatic module and the second thermostatic module alternately approach and move away from the reference axis; and
in the second state, the support device rotates in a reverse direction, the first thermostatic module and the second thermostatic module are fixed, and the first thermal conduction surface and the second thermal conduction surface enclose to form the receive cavity.

6. The partitioned contact temperature cycle test bench for seal material performance of claim 5, wherein the drive device comprises:
a push rod assembly, comprising a push rod disk and push rods, wherein the push rod disk is rotatably provided around the reference axis in the receive cavity, the push rods are slidably connected to the push rod disk to approach or move away from the reference axis, each of the first thermostatic modules corresponds to one of the push rods, each of the second thermostatic modules corresponds to one of the push rods, and the push rod disk drives the support device to rotate;
a special-shaped cam, coaxially provided with and rotatably connected to the push rod disk, wherein the special-shaped cam is provided with transmission portions, each of the push rods corresponds to one of the transmission portions, two sides of the transmission portion are provided with a first match position and a second match position along a circumference direction of the push rod disk, a distance between the first match position and the reference axis is a first distance, a distance between the second match position and the reference axis is a second distance, the first distance is smaller than the second distance, a second guide surface is formed between two adjacent transmission portions, the first match position is smoothly connected to the second guide surface, and the second match position is smoothly connected to the second guide surface; and
a drive member, connected to the special-shaped cam in a transmission manner.

7. The partitioned contact temperature cycle test bench for seal material performance of claim 6, wherein both the first thermostatic module and the second thermostatic module are provided with a guide block, and a side surface of the guide block facing the push rod is a first guide surface;
a distance between a first end of the first guide surface along a circumference direction of the first guide surface and the reference axis is a third distance, a distance between a second end of the first guide surface along the circumference direction of the first guide surface and the reference axis is a fourth distance, and the third distance is greater than the fourth distance;
in case that the push rod is in the first match position, a distance between an end of the push rod away from the reference axis and the reference axis is a fifth distance, and the fourth distance is greater than or equal to the fifth distance; and
in case that the push rod is in the second match position, a distance between the end of the push rod away from the reference axis and the reference axis is a sixth distance, the third distance is greater than or equal to the sixth distance, and the fourth distance is smaller than the sixth distance.

8. The partitioned contact temperature cycle test bench for seal material performance of claim 7, wherein the drive device further comprises:
a groove wheel assembly, provided between the drive member and the special-shaped cam, wherein a groove wheel of the groove wheel assembly is connected to the special-shaped cam in a transmission manner, and an active drive disk of the groove wheel assembly is connected to the drive member in a transmission manner.

9. The partitioned contact temperature cycle test bench for seal material performance of claim 3, wherein the support assembly comprises:
a thermal conduction shell, fixedly provided at the mount seat, wherein the thermal conduction shell is provided with a chamber with a cross-section of an annular sector, and an end of the thermal conduction shell away from the mount seat is open; and
a support block, with a cross-section of an annular sector, the support block is provided with a receive groove for receiving the piece to be tested, the receive groove extends along a circumference direction of the support block, the support block is movably matched with the thermal conduction shell, the support block is switchable between a first position and a second position, in the first position, the support block is located inside the thermal conduction shell and the piece to be tested is in contact with the thermal conduction shell, and in the second position, the support block is located outside the thermal conduction shell.

10. The partitioned contact temperature cycle test bench for seal material performance of claim 9, wherein the support block is slidably matched with the thermal conduction shell, a slide direction of the support block relative to the thermal conduction shell is parallel to the reference axis, and the support device further comprises:
a rotator, rotatably provided around the reference axis at the mount seat;
a connection frame, wherein the support blocks of the pair of support assemblies are both connected to a first end of the connection frame, the connection frame is slidably matched with the rotator, a slide direction of the connection frame relative to the rotator is parallel to the reference axis, a second end of the connection frame is provided with an abutment disk, and the abutment disk is provided with an abutment rod;
an abutment block, slidably connected to the mount seat to approach or move away from the reference axis, wherein a side surface of the abutment block facing the abutment rod is an abutment surface, a distance between an end of the abutment surface close to the reference axis and the abutment disk is a seventh distance, a distance between an end of the abutment surface away from the reference axis and the abutment disk is an eighth distance, and the seventh distance is different from the eighth distance;
a connection rod, wherein an end of the connection rod is rotatably connected to the abutment block, and another end of the connection rod is rotatably connected to the rotator; and
a third elastic member, provided between the rotator and the connection frame, and the third elastic member is used for making the connection frame drive the abutment disk close to the abutment surface.

11. The partitioned contact temperature cycle test bench for seal material performance of claim 9, wherein a fill port for filling a medium into the thermal conduction shell is provided at the support block, and the support assembly further comprises:
a seal member, for sealing the fill port, wherein the seal member is detachably and sealedly connected to the support block.
